(19) United States
(12) Patent Application Publication
(10) Pub. No.: US 2026/0078456 A1
(43) Pub. Date: Mar. 19, 2026

(54) IRON ORE REDUCING AND MELTING APPARATUS AND METHOD

(71) Applicant: PAUL WURTH S.A.

(72) Inventors: Klaus Peter KINZEL, Sandweiler (LU); Fernand DIDELON, Bettembourg (LU); Mehdi BANIASADI, Helmsange (LU); Evangelos DELIKONSTANTIS, Luxembourg (LU); Jihong JI, Steinfort (LU)

(21) Appl. No.: 19/107,881

(22) PCT Filed: Aug. 29, 2023
(86) PCT No.: PCT/EP2023/073602

§ 371 Date: Feb. 28, 2025

(30) Foreign Application Priority Data
Aug. 29, 2022 (DE) 10 2022 121 807.4
Aug. 29, 2022 (LU) LU502718
Aug. 29, 2022 (LU) LU502719

(51) Int. Cl. C21B 7/16; C21B 7/24

(52) U.S. Cl. CPC C21B 7/16; C21B 7/24

(57) ABSTRACT

An iron ore reducing and melting apparatus includes a furnace including from bottom to top: a hearth, a tuyere level, a shaft level and a top level, the blast furnace including at least one first gas injector on the tuyere level, at least one first reducing gas generator connected to the at least one first gas injector, wherein the apparatus is adapted to provide reducing gas including 30-100% (vol/vol) hydrogen on the tuyere level and to operate at a coke rate of below 200 kg/t hot metal.

### BACKGROUND

The production of hot metal (hm) comprising reduced iron generally requires a source of (oxidized) iron, i.e. iron ore, a reduction agent allowing to reduce oxidized forms of iron to reduced iron (coke, reducing gas) and agents whose reaction provide the required reaction temperatures and energy (coke, coal, oxygen, heaters). Due to the use of coke in the reduction process, the reduction process produces substantial amounts of CO₂.

It is generally desirable to reduce the CO₂ output in the reduction process.

Therefore, it is an object of the invention to provide an apparatus and a method capable of producing hot metal which have a reduced CO₂ output.

### SUMMARY

The invention is defined by the appended claims.

Disclosed is an iron ore reducing and melting apparatus comprising:
a furnace, e.g. a blast furnace, comprising from bottom to top: a hearth, a tuyere level, a shaft level and a top level, said furnace comprising at least one first gas injector on the tuyere level, and
a reducing gas generator connected to the at least one gas injector, wherein the apparatus is adapted to operate at a coke rate of below 200 kg/t hot metal.

By providing a reducing agent outside of the furnace it is possible to reduce the amount of coke (and optionally coal) required for the reducing process which is otherwise used to provide reducing agents for the iron ore. The reducing agent, e.g. reducing gas, can comprise hydrogen (H₂) and carbon monoxide (CO). In this way it is possible to achieve coke rates of below 200 kg/t hot metal. Hydrogen is generally provided as molecular hydrogen (H₂)

The reducing agent can comprise 30-100% (vol/vol) hydrogen, optionally further comprising CO 10-70% (vol/vol) with less than 35%, 10% or 5% (vol/vol) of gaseous compounds that are not CO or H₂.

The first reducing agent generator can be a gas reformer providing H₂, especially a syngas reformer providing H₂ and CO.

The blast furnace can also comprise at least one lock hopper for introducing material into the furnace from atmospheric pressure to furnace pressure.

The at least one lock hopper ensures that the pressure within the blast furnace is maintained and thus the reduction and melting process can be maintained.

The iron ore reducing and melting apparatus can further comprise at least one second gas injector on the shaft level.

The position of the at least one second gas injector can be (e.g immediately) above the root of the cohesive zone, the region of the cohesive zone directly contacting the wall of furnace (i.e. above the root of the cohesive zone).

It has been surprisingly found that the total coke requirement can be further reduced by supplying a reducing agent also at the shaft level. In this way, the required temperature level for melting of the ore can be achieved while providing less energy to the reducing agent at tuyere level. Moreover, the amount of reducing agent injected at tuyere level can be reduced. Moreover, with the shaft injection, less gas needs to pass through the high-resistance cohesive zone area.

The at least one first gas injector can comprise at least one electrically driven heater.

An electrically driven heater has the advantage that it can be used to heat the reducing agent without locally consuming coal or coke. Since the heater is electrically driven the energy required for the heater can be produced by CO₂ lean energy. CO₂ lean energy is energy that produces minor CO₂ (photovoltaic, wind, hydro or nuclear energy) or produces not more CO₂ than it uses for its production (biogas from, e.g. non-carbonized plant material).

The path of the reducing agent generated in the reducing gas generator can comprise the reducing gas generator, piping between gas generator and bustle pipe, the bustle pipe, piping between bustle pipe and gas injection point at the furnace (downleg, elbow and blowpipe) and tuyere. The gas injector as used in this document comprises the blow pipe and tuyere.

The apparatus can be adapted to provide heated reducing agent in the piping between gas generator and the bustle pipe, in the piping between bustle pipe and gas injector, and/or in the gas injector. Preferentially, the apparatus can be adapted to provide heated reducing agent in the piping between bustle pipe and the gas injector, or the gas injector.

The apparatus, preferentially, the at least one first gas injector can be adapted to heat the reducing agent to 1600° C.-2600° C., 1900° C.-2300° C., or 2100-2200° C. and to provide the heated gas at the tuyere level to the furnace.

At these temperatures the reduction of the ore by reducing agent is efficient and the amount of coke and coal gasified at the tuyere can be reduced.

The apparatus can be adapted to inject the reducing gas at a volume flow of 500-1300, Nm³/t, 900-1300 Nm³/t or 770-1000 Nm³/t hot metal into the blast furnace at tuyere level.

The apparatus can be adapted to inject the reducing gas at a volume flow of 200-800 Nm³/t, 250-700 Nm³/t or 250-600 Nm³/t hot metal into the blast furnace at shaft level.

At these volume flow values the reduction of the ore by reducing agent is efficient and the amount of coke and coal can be further reduced.

The at least one first gas injector can be designed to heat the reducing agent, to inject the reducing agent at a pressure of at least 2 to up to 10 bar absolute, 5-6 bar absolute, or 4-5 bar absolute.

At these pressure values the reduction of the ore by reducing agent is efficient and high productivities can be attained.

Preferably each of the above three conditions regarding temperature, volume flow and pressure with regard to the at least first gas injector can be combined.

The at least one electrically driven heater of the at least one first gas injector is adapted to operate at an electric power of 200-700 kwh/t, 250-600 kwh/t, or 300-550 kwh/t of hot metal.

The electric power is suitable for heating the reduction agent to the desired temperatures.

The electrically driven heater can be a plasma torch. A plasma torch is an electrically driven device capable of heating gas to the physical state of plasma. Plasma torches can provide high gas temperatures, unattained by conventional heating systems. Moreover plasma torches allow a flexible operation with regard to flowrates and temperature. In addition, it is compact technology having a low volumetric footprint.

A plasma torch can be especially (energy) efficient in providing the desired temperatures and is especially efficient when heating a gas from an already high temperature to an even higher temperature which is almost not efficiently possible with standard technologies. Thus, one can use the plasma torch with reduced power requirement by configuring the apparatus to provide gas heated to at least 900° C. or preferably 1100° C. to the plasma torch.

The plasma torch can be an electrode-comprising or electrodeless plasma torch.

In an electrodeless plasma torch, the plasma is inductively ignited, thus no electrodes are needed.

Electrodeless plasma torches can be microwave (MW) plasma and radiofrequency (RF) plasma torches.

The plasma torch can also be an electrode-comprising plasma torch. The electrodes can be graphite electrodes.

Electrode-comprising plasma torches can be a direct current plasma torch (DC plasma torch) or an alternating current plasma torch (AC plasma torch), especially, a 3-phase alternating current plasma torch.

Electrode-comprising plasma torches are very energy efficient in providing the required temperatures to the gas which is to be injected into the furnace.

Direct current plasma torches have the advantage that they are rather compact in size, i.e. do not require substantial amounts of space.

Alternating current plasma torches, particularly 3-phase alternating current plasma torches are less compact in size, but provide a number of advantages.

Alternating current plasma torches, particularly 3-phase alternating current plasma torches provide a diffusive plasma. The plasma is confined in the ignition area allowing a better control of the position of the plasma. Due to the alternating current the electrodes are naturally cooled which prolongs their lifetime. Alternating current plasma torches can be water-cooled. Using an appropriately designed shell helps in optimizing the heat transfer and efficiency losses. Alternating current plasma torches do not require swirl gas like direct current plasma torches and the design of the torches is simplified. Since the elongation of the plasma can be limited, refractory materials are only required in a small area.

The inter-electrode distance of the plasma torch, particularly of the 3-phase alternating current plasma torch can be adjustably employing moving inclined electrodes. The inter-electrode distance may be 0-100 mm, 5-50 mm, or 40 mm. The adjustability allows for easy plasma ignition and higher plasma controllability and thus, stability.

Alternating current plasma torch, particularly the 3-phase alternating current plasma torch can have 3 or a multiplicity of 3 electrodes (e.g. 3, 6, 9, 12, 15, 18, 21 electrodes ore more). A higher number of electrodes can improve the control of the plasma and increase the plasma torch power.

Direct current plasma torch can have 2 or a multiplicity of 2 electrodes (e.g. 2, 4, 6, 8, 12, 14, 16, 18, 20). A higher number of electrodes can improve the control of the plasma and increase the plasma torch power.

The total power demand of a furnace as defined above is 25-280 MW, largely depending of course on the production level of the furnace.

Plasma torches, especially direct current plasma torches or/and alternating current plasma and/or 3-phase alternating current plasma torches of power 1-10 MW, preferably 2-8 MW, most preferably 3 to 5 MW, may be used in the furnace as defined above.

In the furnace as defined above at least 10 gas injectors and up to 70 gas injectors, most preferably 18-40 are used.

In this way the gas injected into the furnace is uniformly heated providing efficient metal product.

The apparatus can further comprise power supplies powering the at least one plasma torch or torches.

Preferably, one power supply powers 1-5, 1-3, or 1 of the at least one plasma torches.

Use of multiple plasma torches powered by multiple power supplies of up to 30 MW or <10 MW (one power supply drives at least one plasma torch) has advantages over using one power supply of total capacity equal to the summation of the capacities of all low-capacity power supplies. The flickering imposed to the electrical grid by plasma torch operation fluctuation in the former case is way less severe than in the latter. It can be advantageous to use a power supply with up to 3 times the power of the individual plasma torch in combination with each respective plasma torch to provide a stable operation.

Moreover, using multiple power supplies of up to 30 MW or <10 MW gives better controllability and flexibility: when a power supply fluctuates or crashes, there is no disturbance propagation to the whole system and the furnace may keep running without severe issues since the other power supplies can collectively provide the power input of the crashed power supply.

In addition, one or more spare power supplies can be installed online and in case of failure of a main power supply, a switching over to the spare one assures steady-state operation at full power. During the next planned maintenance shift, the repair can be done, thereby, a production loss never occurs.

Yet, high number of power supplies lead to high cost, high power losses and high space requirements, thus, an optimum number of power units has to be selected. In the furnace as defined above at least 10 power units and up to 70 power units, most preferably 18-40 power units are used.

The plasma torches can be 3 phase AC plasma torches which are adapted to provide a (gas) velocity within the arc perimeter of the plasma torch of 10-120 m/s, preferably 15-80 more preferably 18 to 60 m/s. Within these ranges the optimal conditions for heating the gas are provided. In case that not all gas to be heated can pass through this perimeter, The remainder of the gas to be heated will be supplied outside of this perimeter.

In addition it provided a plasma torch and a method of using that plasma torch that reduces the thermal load on the wall lining surrounding the plasma torch.

Thus, the plasma torch can be adapted to split the incoming gas into two streams. In particular, the configuration of the plasma torch provides a first stream flowing centrally through the arc created by the plasma torch and a second stream flowing peripherally around the arc.

The central stream can flow through the plasma arc and will be heated to very high temperature. The second stream, which can be injected shortly downstream of the plasma arc, is orientated in such way that it acts as a protection of the refractory lined walls of the plasma burner chamber from the heat of the central high temperature stream. This reduces the thermal load on the wall lining.

The iron ore reducing and melting apparatus can further comprise a plasma torch electrode exchanging/amendment device adapted to automatically replace at least one used/eroded electrode of the plasma torch with a new electrode/amend the used/eroded electrode with at least one new electrode while the torch keeps operating.

In an alternating current plasma torch, particularly in 3-phase alternating current plasma torch, the electrodes generally have a rod shape. During operation, the side of the rod facing the region where the plasma is generated degrades and the length of the electrode is shortened. The plasma torch comprises a feeding device ensuring that the inter-electrode distance of the side of the rods facing the region where the plasma is generated is maintained by pushing the electrodes towards the plasma generating region. After a predetermined minimum length of the electrodes the plasma torch electrode exchanging/amendment device can exchange or amend the electrodes.

Amending the electrodes is achieved by connecting the backside of the electrode (opposite the side of the electrode facing the region where the plasma is generated) with a new electrode (e.g. by a compatible protrusion and receiving opening on the used and new electrode, the protrusion and opening may be compatibly threaded). The attachment of the new electrode to the old electrode is achieved by an electrode gripping device (gripper). The electrode amending device has the advantage that the operation of the apparatus is minimally disturbed when amending the electrode.

Alternatively or in addition, the iron ore reducing and melting apparatus may contain an electrode paste column or paste feeder. The electrode paste column or paste feeder can be used to amend graphite electrodes with a (e.g. carbon) paste. The intense heat and electrical currents during the plasma operation cab cause the graphite electrodes to gradually erode and get consumed. Such a method amending the electrodes with the paste can at least partially or completely reverse the erosion or consumption. The carbon paste, typically a mixture of graphite and binders, is applied to the consumed or worn-out portions of the electrodes.

This paste replenishes the carbon content, extends the electrode's life, and helps maintain efficient electrical conductivity and heat transfer during the plasma operation.

The electrode paste column or paste feeder is adapted to introduce the carbon paste into the electrode column without interrupting the plasma process.

The process involves bringing the electrode paste column onto the consumed or eroded portion of the graphite electrode. The column contains the carbon paste mixture, which is then gradually pushed into the electrode column. As the paste is introduced, it fills the voids left by the consumed electrode material and restores the carbon content.

This method allows for a controlled and precise addition of carbon paste, ensuring that the electrode's performance and efficiency are maintained throughout the plasma operation. It helps extend the electrode's operational life and contributes to the overall effectiveness of the plasma operation.

In a direct current plasma torch, the electrodes may have a tubular shape. During operation, the side of the tube facing the region where the plasma is generated degrades and the thickness of the electrode is shortened. A plasma torch electrode exchanging device removes the torn electrode from the plasma torch and positions a new electrode into the plasma torch. The replacement of the used electrode with the new electrode is achieved by a further electrode gripping device (gripper).

The plasma torch electrode exchanging/amendment device is controlled by a controlling unit (e.g. a computer device) which determines the status of the electrodes in use (e.g. by appropriate cameras or the electrical characteristics of the plasma torches). When said controlling unit determines that the minimum length/thickness of the electrode has been reached, the controlling unit instructs the exchanging/amendment device to exchange or amend the used electrode.

The plasma torch electrode exchanging/amendment device can comprise a magazine for unused (new) electrodes. The plasma torch electrode exchanging/amendment device can further comprise a magazine for used electrodes. In this way, the plasma torch electrode exchanging/amendment device can operate without manual interaction for a predetermined time.

The blast furnace can comprises a plurality of first or/and second gas injectors.

The blast furnace can comprise at least 10 first gas injectors and up to 70 first gas injectors, most preferably 18-40 first gas injectors.

In addition, the blast furnace can comprise at least 10 second gas injectors and up to 70 second gas injectors, most preferably 18-40 second gas injectors.

The plurality of first and/or second gas injectors can be arranged substantially equidistantly and/or circularly.

The outlets of the respective injectors can be evenly distributed at distance between 0.5 and 2.5 m, and preferably between 1.0 and 1.5 m between each other.

The iron ore reducing and melting apparatus can further comprise at least one sensor adapted to analyze the composition of the gas at the top level. The sensor can be inside the furnace within the top level or can be connected to a piping which retrieves gas from the top level of the furnace.

The sensor can be of an electrochemical, catalytic bead (pellistor), photoionization, infrared point, infrared imaging, semiconductor, or ultrasonic type. The sensor of the semiconductor type can be a metal-oxide-semiconductor sensor. The sensor can be comprised in a gas chromatograph.

The at least one sensor can be adapted to detect a CO, CO₂, or/and H₂ concentration of the gas. The at least one sensor can also be adapted to detect a H₂O, N₂, or/and CH₄ concentration in the gas.

The iron ore reducing and melting apparatus may further comprise a gas injector regulating device configured to adapt the composition of the gas and/or the volume of the gas injected by the first and/or second gas injectors based on the determined gas composition and/or temperature at the top level.

The gas injector regulating device may also adapt the power supply to the at least one electrical heater based on the determined gas composition at the top level and/or temperature at the top level.

The gas injector regulating device may also be configured to adapt the composition of the gas and/or the volume of the gas injected and/or the temperature of the gas injected by the first and/or second gas injectors based on the composition and/or temperature of the hot metal outputted by the apparatus and the hot metal production rate. To determine the composition of the hot metal outputted by the apparatus and the hot metal production rate, the apparatus comprises further sensors positioned at the hot metal outlet of the furnace configured to determine the composition of the hot metal and to determine the volume of the hot metal.

The apparatus as defined above has the advantage that the oxygen consumption during hot metal production can be reduced and thus the CO₂ emissions be reduced.

Accordingly, the iron ore reducing and melting apparatus can further comprise an oxygen supply device adapted to inject gas comprising oxygen at a lower amount than in usual melting and reducing apparatuses. The oxygen supply device may be adapted to inject gas comprising oxygen at less than 120 Nm³/t hot metal, less than 80 Nm³/t hot metal, less than 40 Nm³/t hot metal, or less than 30 Nm³/t hot metal. For example, the oxygen supply device may adapted to inject gas comprising oxygen at 1-120 Nm³/t hot metal, 1-80 Nm³/t hot metal, 1-40 Nm³/t hot metal, 1-30 Nm³/t, or 0 Nm³/t.

The gas comprising oxygen may comprise at least 75% (vol/vol) oxygen, or at least 95% (vol/vol) oxygen. For the example, the gas comprising oxygen may comprise 75%-99% (vol/vol) oxygen, or 95%-99% (vol/vol) oxygen.

Optionally, the iron ore reducing and melting apparatus comprises a device supplying oxygen into the blast furnace. The device for supplying oxygen is preferably used for transient phases only (e.g. restart after maintenance stoppage).

The iron ore reducing and melting apparatus may further comprise a gas cleaning device adapted to recycle the top gas of the blast furnace. The gas cleaning device may be connected by a piping to the top level of the blast furnace. The gas cleaning device may include a pressure regulation device to control the pressure at the top of the furnace in the range 1 to 10 barg, more preferably 1.5 to 6 barg, most preferably 2 to 4 barg. The gas cleaning device is adapted to remove dust, H₂O, and optionally sulphur, chlorine and/or other undesirable compounds.

A reducing gas generator can be a gas reformer or a CO₂ removal device. The use of a gas reformer is preferred. A reducing gas generator can also be a H₂ removal device which provides H₂. The removed H₂ can be used as the reducing gas in the process, the remaining part can be used in burners. A sorbent enhanced water gas shift reactor which transforms CO to H₂ can also be part of the reducing gas generator. For example, in combination with a H₂ removal device H₂ recovery can be further increased.

The gas output by the reducing gas generator may comprise a reductant to oxidant ratio (CO+H₂)/(CO₂+H₂O) in % (vol/vol) that is bigger than 7, 8, or 9. The ((CO+H₂)/(CO₂+H₂O))ratio may be 6-80, 7-30, or 8-12.

Since those portions of gas from the top level suitable for providing and/or producing reducing gas are at least partially reused the amount of reducing gas, especially hydrogen, that has to be supplied by the first reducing gas generator can be reduced. Thus, the amount of reducing gas or components providing reducing gas required can be reduced. A part of the top gas can also be used in burners and/or reform the gas.

The iron ore reducing and melting apparatus may be adapted to provide (possibly cleaned/treated) top gas containing hydrogen to the gas coming from the gas generator supplying gas to the second injector (e.g in case its temperature is higher, especially when in non-catalytic reforming for the cooling of the reducing gas going to the shaft injectors).

The connections between the various devices of the apparatus may be provided by suitable piping.

The first reducing gas generator may be catalytic or non-catalytic reformer, a regenerative reformer without a catalyst configured to provide reducing gas at a temperature of 1100° C. or higher.

Using such a reformer providing reducing gas at a temperature of 1100° C. or higher and providing hydrogen into the reducing gas has the advantage that the reducing gas is already preheated to relatively high temperatures before it is heated in the first one or/and second gas injectors. In addition, the ((CO+H₂)/(CO₂+H₂O))-ratio is improved in comparison with a catalytic process working at a lower temperature level.

Disclosed is also a method for reducing and melting iron ore in a blast furnace comprising the steps of:
injecting a superheated reducing gas at a temperature of 1600° C.-2600° C. into the furnace at tuyere level; wherein the volume flow of the reducing gas injected at tuyere level is 500-1300 Nm³/t hot metal and the reducing gas comprises 30-100% (vol/vol) H₂, and wherein the coke rate of the method is below 200 kg/t hot metal;
thereby providing hot metal.

It has been surprisingly found that using hydrogen in the amount defined above in combination with the volume flow of the reducing gas injected at tuyere level as defined above substantially reduces the coke rate.

The method can be implemented using the apparatus defined above.

The method can further comprise injecting reducing gas at a temperature of 800° C.-1000° C. into the furnace at shaft level.

It has been surprisingly found that additionally injecting reducing gas as defined above further reduces the coke rate.

The method can also comprise injecting reducing gas at shaft level substantially along the circumference of the blast furnace such that the gas ascending from the cohesive zone is centered within the blast furnace.

It has been surprisingly found that injecting reducing gas as defined above reduces the coke rate.

The ratio between the volume flow of the reducing gas injected at shaft level and the volume flow of the reducing gas injected at tuyere level is from 0:1 to 1:1.

In other words, a ratio of 0:1 covers the case where no reducing gas in injected at shaft level and reducing gas is injected only at tuyere level.

If reducing gas is additionally injected at shaft level the coke rate is reduced until an optimum when increasing the amount of gas injected at tuyere level. Thus, the ratio between the volume flow of the reducing gas injected at shaft level and the volume flow of the reducing gas injected at tuyere level is from 1:10 to 1:1, 1:5 to 8:10, 1:3 to 7:10, 0.4 to 0.7, or 0.6 to 0.65.

The method can comprise not using any auxiliary fuel injection (e.g. coal) in the execution of the method.

In the method as defined above the hydrogen in the reducing gas can comprise hydrogen generated from renewable energy fully/partially and/or from natural gas reforming with or not carbon capture and/or wherein the reducing gas is heated and/or superheated electrically using renewable energy fully/partially and/or lean CO₂ electricity as from nuclear.

### BRIEF DESCRIPTION OF FIGURES

FIG. 1 illustrates an iron ore reducing apparatus as disclosed comprising a blast furnace and a first reducing gas generator.

FIG. 2 illustrates the zones within a blast furnace and the injection sites for the various gasses that can be injected into the blast furnace

FIG. 3 illustrates the zones within a blast furnace

### DESCRIPTION OF THE DISCLOSURE

### Figures

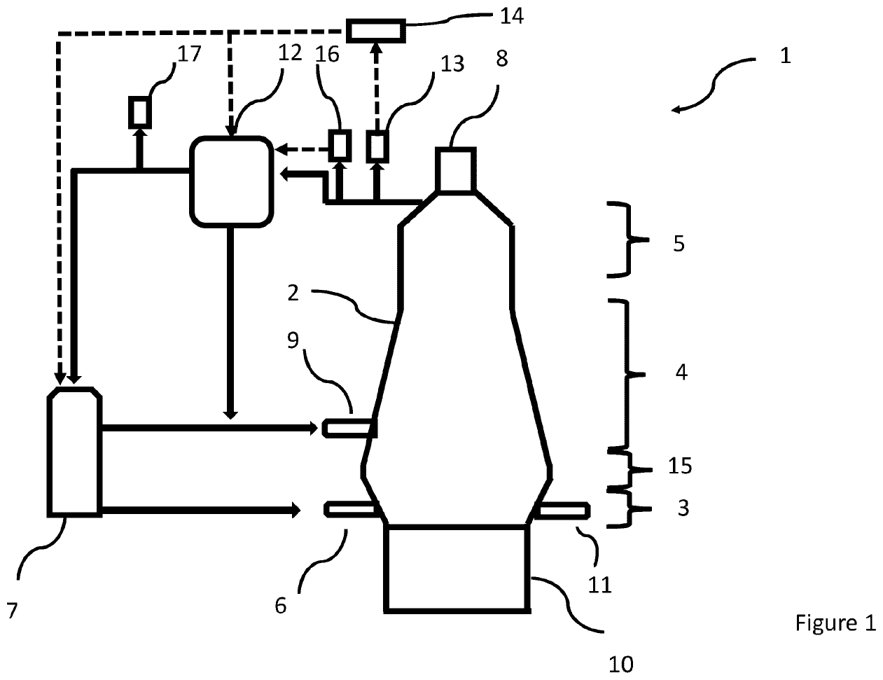

FIG. 1 illustrates schematically an iron ore and melting apparatus 1 as disclosed in this application. Each of the elements of the apparatus, especially, the devices, generators etc. are also separated disclosed. In addition, the apparatus 1 as disclosed can comprise any number of the illustrated devices, generators etc.

The arrows with solid lines symbolize piping and the direction of the flow of gas within the apparatus 1. The arrows with dotted lines symbolize wireless or wired communication lines within the apparatus 1, especially communication lines to and from control devices.

The apparatus 1 comprises a blast furnace 2. The blast furnace 2 from bottom to top comprises a hearth 10, a region comprising the tuyeres, i.e. a tuyere level 3, a shaft region comprising the shaft level 4, and a top level 5.

On the tuyere level 3, a first gas injector 6 is installed. The first gas injector 6 is used to inject reducing gas into the blast furnace 2. The tuyere level 3 (or region) can also be used to inject oxygen into the blast furnace 2 via an oxygen supply device 11.

The first gas injector can comprise an electrically driven heater, preferentially a plasma torch (not illustrated).

A lock hopper 8 is used to provide material (e.g. coke, ore, and optionally fluxes) to the interior of the blast furnace while securing that the pressure conditions in the blast furnace 2 are maintained. On the shaft level 4 the blast furnace can also comprise at least one second gas injector 9, which can be used to inject reducing gas into the shaft level/region.

Both the first and second injectors 6 and 9 can receive reducing gas from the reducing gas generator 7. The reducing gas generator 7 can be a syngas generator. The reducing gas provided by the reducing gas generator 7 can comprise 30-100% (vol/vol) of hydrogen. The reducing gas can be produced by the reducing gas generator 7 from natural gas, coke oven gas or another hydrocarbon source. The reducing gas generator 7 can also use hydrogen that is provided from a local or remote hydrogen storage and be green or blue hydrogen. The hydrogen can be obtained with an electrolyzer. Alternatively the reducing gas generator can also produce the reducing gas by H₂O and/or CO₂ separation from a H₂ and/or CO rich gas as the furnace top gas, BOF gas or others. A common or separate reducing gas generator may be used for the tuyere and shaft level. The separate reducing gas generators may be of the same or different type.

The gas which is present in the top level can be constantly or intermittently withdrawn from the top level 5 of the furnace 2. The gas withdrawn from the top level can be recycled using the gas cleaning device 12 and optionally a gas preparation device (not shown) removing some components like water, chlorines, sulphur components like COS, or/and heavy metals. The gas processed by the gas cleaning device 12 (and optionally the gas preparation device) can be provided to the reducing gas generator 7 or provided into the path (after the reducing gas generator 7) leading to the injectors at shaft level 4. In this position it is also very advantageous to supply cleaned BOF gas due to its high reduction degree.

The gas can be analyzed by a sensor 13 with contact to the retrieved gas. While the sensor 13 is shown in FIG. 1 to be at the dead end of a piping connected to the furnace 2, the sensor 13 can also be provided in the furnace or any other piping with access to the gas retrieved from the top level 5. A further sensor 17, at least a sensor or humidity and/or temperature may be provided after the gas cleaning and water removal since the water content in the gas can be a relevant factor for the stoichiometric control of the mix gas (hydrocarbon source and top gas) that goes to the gas reformer. The sensors 13 and/or 17 provide data to gas injector regulating device 14. Gas injector regulating device 14 comprises an electrical circuit with a memory capable of processing the data provided by the sensor 13 and sending signals to the first or/and second gas injectors 6, 12, the reducing gas generator 7 and/or the gas cleaning device 12. For example, the gas output, the composition and temperature of the gas output, from the reducing gas generator or the gas cleaning device 12 may be accordingly adapted. For example, the temperature of the gas provided by the gas injectors may be adapted by in-/or decreasing the power supplied to the plasma torch. The gas injector regulating device 14 can also process the input from other sensors like sensors examining the hot metal quality or hot metal production rate. Based on the data provided by the sensors the gas injector regulating device 14 can modify the composition of the gas produced by the gas generator 7 or the conditions applied the first or/and second gas injectors 6, 9 (e.g. temperature, pressure, volumetric flow).

The gas pressure can be measured by a sensor 16 with contact to the retrieved gas. While the sensor 16 is shown in FIG. 1 to be at the dead end of a piping connected to the furnace 2, the sensor 16 can also be provided in the furnace or any other piping with access to the gas retrieved from the top level 5. The sensor 16 provides data to the pressure regulation device included in the gas cleaning device 12.

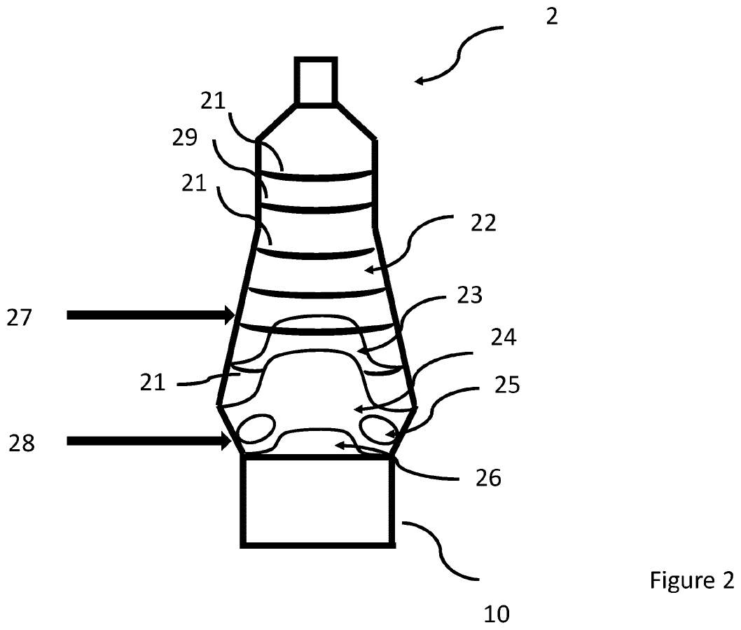

FIG. 2 illustrates the zones within a blast furnace and the injection sites for the various gasses that can be injected into the furnace.

The material within an operating furnace 2 comprises from top to bottom a shaft region 22 and the cohesive zone 23. The shaft region 22 and the cohesive zone 23 comprise alternating layers of material comprising ore 29 and coke 21. Following the cohesive zone 23 is the dripping zone 24 which comprises close to the tuyeres the raceways 25.

At the tuyere level 28 reducing gas, oxygen, and or hot blast can be injected into the furnace 2. At the shaft level 27 reducing gas can be optionally injected into the furnace 2. The shaft level 27 can also be considered to be the level at which the stack angle of the belly 15 turns from 0° to a value that is different from 0°. Alternatively, the shaft level is the level which starts at the root of the cohesive zone 23.

Reference examples and examples of the disclosure

To better illustrate the disclosure, several cases have been deeply investigated. The details of the cases are presented in Table 1.

### Cases 1 and 2

Case 1 and 2 are reference apparatuses running today with coarse coke rate of 255 kg/tHM and 205 kg/tHM respectively.

Case 3 and 4 are reference apparatuses with hot hydrogen injected to tuyere without and with hot hydrogen injection to the shaft respectively.

Cases 5 and 6 are the new furnaces (apparatus comprising furnace of the present disclosure) with a coke rate of 180 kg/tHM and nearly 100 kg/tHM using a superheated syngas injection at tuyere level.

Cases 7 and 8 are about the new furnaces (apparatus comprising further furnaces of the present disclosure) with a coke rate of 180 kg/tHM and 100 kg/tHM using a superheated syngas injection at tuyere level, and addition to that, an injection of a hot syngas into the shaft.

Case 1 represents a typical well operated blast furnace with high pulverised coal injection as one can find several all over the world and specifically in Europe. The pulverised coal injection (PCI) allows to reduce the lump or coarse coke rate to values of about 250 kg/t HM.

As one can see this furnace requires about 235 Nm³ of total oxygen per t of produced hot metal. Part of this oxygen comes with the heated air, part of it comes from oxygen enrichment with pure oxygen coming from an air separation plant.

This oxygen enrichment is required since the blast furnace requires a certain flame temperature in order to operate correctly. In fact the flame temperature assures that the reduced ore can be molten and that the injected coal can be burnt within the raceway. With high PCI injection the required flame temperature is about 2200° C.

Case 2 represents a typical blast furnace reaching exceptionally high PCI injection. Such operations have already been sustained for long production periods of several months. This operation is however quite challenging and requires high operational skills and very good raw materials, in particular, high quality of costly cokes.

If one compares the injection conditions at the tuyere, one can see that the oxygen enrichment had to be further increased, but all together the conditions at the tuyere, hot blast temperature, gas volume flow rate, have not changed drastically.

Both these operations are of course not desirable if one wants to reduce the CO₂ emissions from the hot metal production since the complete energy and reductant input is based on coal.

### Cases 3 and 4

In these reference cases the operation of a blast furnace was analysed using high hydrogen injection rates in order to reduce part of the energy and reductant input from coal and use instead CO₂ free hydrogen.

It is known that hydrogen cannot be injected in big quantities if injected cold at the tuyere together with oxygen enriched hot blast. The typical maximum amount of hydrogen utilisation is restricted to below 30 kg/t HM.

Thus the addition of hydrogen will require a change. It needs to be injected hot, only at tuyere level or at both tuyere and shaft level.

As injection temperature we have assumed 950° C. at shaft level and 1200° C. at tuyere level.

These are the temperature levels one can typically reach when using traditional heat exchangers and regenerative type heaters.

At tuyere level cold oxygen needs now to be added in order to burn some coke for reaching the required flame temperature for melting of the ore. From furnaces which are not using PCI injection but natural gas injection it is known that in this case the flame temperature can be reduced to a minimum of about 1800-1850° C., always requiring a sufficient flow rate to supply enough energy for melting the reduced ore and supply the energy for the heating and reduction of the ore in the shaft of the blast furnace.

As one can see, it is possible to reduce the oxygen injection at the tuyere from about 240 to 150 and 180 Nm³/t HM respectively. Thus, less carbon can be burned at the tuyere. However since there is no carbon available from PCI injection the coke that needs to be burned at the tuyere is higher as in the cases 1 and 2, leading to an increased coke rate.

Carbon by the way is the only element contained in typical fuels that can burn with oxygen at the tuyere conditions to form CO and thus heat the injected gas. CO₂ and H₂O cannot be formed at the reducing conditions which we find at the tuyere. In case that CO₂ and/or H₂O are present in the injected gas they will have the adverse effect that coke will be consumed by endothermal gasification resulting in a lowering of the flame temperature.

This contradiction of additional coal/coke requirement when using hydrogen in a blast furnace, versus required CO₂ emission reduction cannot be overcome with conventional methods.

Additionally one can see that pure hydrogen injection would in both cases, with and without shaft injection require huge amounts of hydrogen, 1070 and 1280 Nm³ of hydrogen per t of hot metal with and without shaft injection respectively. This is exceeding by far the hydrogen requirement of other production routes such as the direct reduction process requiring about 660 Nm3/t HM hydrogen. Moreover the required coke rate in these cases are quite high making them uninteresting.

To overcome this problem the injection of a syngas with or without pure hydrogen addition is proposed, at superheated temperatures to the blast furnace.

The superheating can be done, for example, by plasma torches.

### Cases 5 and 6:

In these cases, superheating the gas that is injected at tuyere level has the advantage that we now do not need to burn coke with oxygen to have the temperature level at the tuyere required for melting of the reduced ore.

### Cases 7 and 8:

These cases have additional syngas injection into the shaft compared with the cases 5 and 6.

When the furnace is operated with partly injecting the gas in the shaft of the furnace to be able to supply the required temperature level for melting with a lower electric energy requirement of the plasma torch. Moreover, with the shaft injection, less gas needs to pass through the high-resistance cohesive zone area.

As one can see, it is now possible to reach very low coke rates, in the two examples about 180 and 100 kg/t hm respectively.

The addition of hydrogen is also very low in case of 100 kg/thm coke with 440 Nm³/t hm.

This addition of hydrogen can be reduced by recycling the top gas of the blast furnace back to the blast furnace via the reducing gas generator.

For this the content of dust, H₂O and CO₂ needs to be reduced. Dust can be reduced in dry or wet gas cleaning systems. In case of wet gas cleaning systems also a part of the H₂O will be removed. The H₂O can be, if required, easily further reduced by cooling and condensation (e.g by a condenser, quench or the like). Other removal systems can be used to treat unwanted components such as oxygen, chlorines, Sulphur components such as COS, heavy metals, and others. The CO₂ elimination can be achieved with any CO2 removal technology such as MEA, pressure swing adsorption (PSA), vacuum pressure swing adsorption (VPSA) and also reforming of CO₂ with hydrocarbons to form CO and hydrogen.

In our example the reforming with natural gas has been applied.

The reforming can be done catalytically at temperatures of about 950° C. or without catalyst in a regenerative reformer type at elevated temperatures >1100° C.

Since specifically at the tuyere level very high temperatures are desired, the latter type is very well suited for preparing the gas at the tuyere level.

Also when reforming the gas at high temperatures, it is possible to reach a very high reduction degree of the gas (CO+H₂)/(CO₂+H₂O)>7 preferable >8 more preferably >9. High reduction degrees are very important to reach a low coke rate since every CO₂ and H₂O in the gas and injected at the tuyere will consume coke in the raceway and decrease the flame temperature.

CO₂ and H₂O injected at the shaft level will lower the direct reduction degree of the ore going to the cohesive zone requiring thus coke for its complete reduction in the direct reduction zone.

TABLE 1

| | | | | | Case 5 | Case 6 | | |
|---|---|---|---|---|---|---|---|---|
| | | | | Case 4 | New furnace | New furnace | Case 7 | Case 8 |
| | | | Case 3 | apparatus | with 180 | with 100 | New furnace | New furnace |
| | | | apparatus | with hot | kg/tHM, | kg/tHM, | with 180 | with 100 |
| | Case1 | Case2 | with hot | H₂ injected | without | without | kg/tHM, | kg/tHM, |
| | Apparatus | Apparatus | H₂ injected | to tuyere | shaft | shaft | with shaft | with shaft |
| | 1 | 2 | to tuyere | and shaft | injection | injection | injection | injection |
| Total coke rate | 301 | 256 | 274 | 324 | 180 | 114 | 177 | 102 |
| Lump Coke rate (kg/tHM) | 255 | 205 | 274 | 324 | 180 | 114 | 177 | 102 |
| Nut Coke rate (kg/tHM) | 46 | 51 | 0 | 0 | 0 | 0 | 0 | 0 |
| PCI (kg/tHM) | 192 | 232 | 0 | 0 | 0 | 0 | 0 | 0 |
| Cold O2 (Nm³/tHM) | 63 | 89 | 148 | 183 | 71 | 1.9 | 75 | 6 |
| Natural dry blast volume | 821 | 740 | 0 | 0 | 0 | 0 | 0 | 0 |
| (Nm³/tHM) | | | | | | | | |
| Total O2 (Nm³/tHM) | 235 | 244 | 148 | 183 | 71 | 1.9 | 75 | 6 |
| Flame temperature (° C.) | 2230 | 2175 | 1796 | 2225 | 1876 | 1848 | 2032 | 1997 |
| Top gas volume, dry (Nm3 | 1392 | 1337 | 1285 | 1209 | 1005 | 1011 | 1084 | 1206 |
| dry/tHM) | | | | | | | | |
| LHV of top gas, kJ/Nm³ (dry) | 3574 | 3673 | 9781 | 9496 | 7809 | 8914 | 7846 | 9065 |
| reducing gas injected to the | 0 | 0 | 0 | 310 | 0 | 0 | 300 | 565 |
| shaft, (Nm³/tHM) | | | | | | | | |
| Reducing gas injected to | 0 | 0 | 1280 | 760 | 947 | 1200 | 760 | 889 |
| tuyere (Nm³/tHM) | | | | | | | | |
| Temperature of hot reducing | 1250 | 1150 | 1200 | 1200 | 1750 | 2020 | 1820 | 2150 |
| gas or natural hot blast | | | | | | | | |
| injected to tuyere, (° C.) | | | | | | | | |
| Electricity consumption for | | | | | 273 | 516 | 242 | 435 |
| plasma, kWh/tHM | | | | | | | | |

As we would like to discuss the impact of several gases generated or injected into the furnace on the critical issues, it is better to introduce them and identify their positions as illustrated in FIG. 2 to avoid any misunderstanding.

The volume flow rate of these gases is summarized in the following table:

TABLE 2

| | | | | | Case 5 | Case 6 | | |
|---|---|---|---|---|---|---|---|---|
| | | | | Case 4 | New furnace | New furnace | Case 7 | Case 8 |
| | | | Case 3 | apparatus | with 180 | with 100 | New furnace | New furnace |
| | | | apparatus | with hot | kg/tHM, | kg/tHM, | with 180 | with 100 |
| | Case1 | Case2 | with hot | H₂ injected | without | without | kg/tHM, | kg/tHM, |
| | Apparatus | Apparatus | H₂ injected | to tuyere | shaft | shaft | with shaft | with shaft |
| | 1 | 2 | to tuyere | and shaft | injection | injection | injection | injection |
| Reducing gas into the | 0 | 0 | 0 | 310 | 0 | 0 | 300 | 565 |
| shaft,(Nm³/tHM) | | | | | | | | |
| H₂ used for reducing gas | 0 | 0 | 0 | 0 | 0 | 440 | 0 | 440 |
| production (Nm³/tHM) | | | | | | | | |
| NG used for reducing gas | 0 | 0 | 0 | 0 | 180 | 95 | 191 | 106 |
| production (Nm³/tHM) | | | | | | | | |
| Hot blast injected to | 821 | 740 | 0 | 0 | 0 | 0 | 0 | 0 |
| tuyere (Nm³/tHM) | | | | | | | | |
| O2 injected to tuyeres | 63 | 89 | 148 | 183 | 71 | 2 | 75 | 6 |
| (Nm³/tHM) | | | | | | | | |
| Reducing gas injected to | 0 | 0 | 1280 | 760 | 947 | 1200 | 760 | 889 |
| tuyere (Nm³/tHM) | | | | | | | | |
| Gas volume at tuyeres | 1247 | 1217 | 1538 | 1076 | 1135 | 1240 | 920 | 939 |
| (Nm³/tHM) | | | | | | | | |
| Gas volume in the bosh | 1398 | 1332 | 1577 | 1147 | 1154 | 1294 | 966 | 969 |
| (Nm³/tHM) | | | | | | | | |

### Coke Consumption

Coke in the apparatus is consumed by the solution loss reaction in the shaft, carburization, direct reduction in liquid state (upper part of the dripping zone), and coke gasification/combustion in the tuyere. Moreover, a little amount of coke fines are captured by the top gas.

In the table below, the amount of coke consumed by the mentioned means for all cases are presented.

TABLE 3
coke repartition for all cases

| | | | | | | Case 5 | Case 6 | | |
|---|---|---|---|---|---|---|---|---|---|
| | | | | | Case 4 | New furnace | New furnace | Case 7 | Case 8 |
| | | | | Case 3 | apparatus | with 180 | with 100 | New furnace | New furnace |
| | | | | apparatus | with hot | kg/tHM, | kg/tHM, | with 180 | with 100 |
| | | | | with hot | H2 injected | without | without | kg/tHM, | kg/tHM, |
| | | Case1 | Case2 | H2 injected | to tuyere | shaft | shaft | with shaft | with shaft |
| | | Apparatus1 | Apparatus2 | to tuyere | and shaft | injection | injection | injection | injection |
| Coke burnt/gasified at | kg/tHM | 127 | 93 | 171 | 210 | 92 | 24 | 92 | 24 |
| tuyere | | | | | | | | | |
| Coke solution loss | kg/tHM | 22 | 29 | 23 | 11 | 17 | 17 | 13 | 10 |
| shaft | | | | | | | | | |
| Coke for carburization | kg/tHM | 51 | 55 | 51 | 51 | 51 | 51 | 51 | 51 |
| Coke for direct reduction | kg/tHM | 91 | 70 | 19 | 40 | 13 | 18 | 14 | 12 |
| Coke in dust and sludge | kg/tHM | 11 | 10 | 11 | 12 | 7 | 4 | 7 | 4 |
| Total coke with dust and | kg/tHM | 301 | 257 | 274 | 324 | 180 | 114 | 177 | 102 |
| sludge | | | | | | | | | |

It can be seen that, the coke consumption by direct reduction in liquid state is significantly lower for the new furnace. The reason is that the ferrous burden is reduced to a very high degree in the shaft, thanks to very high reductant to oxidant ratio in the furnace. Therefore, less FeO remains to be reduced to Fe° by direct reduction and solution loss reaction. For the cases 5-8, coke consumption by direct reduction is below 20 kg/tHM whereas for the conventional furnace it is greater than 70 kg/tHM.

It can be also seen that in the cases 7 and 8, the injected reducing gas into the shaft limits the coke consumption by the solution loss. It is therefore considered that the injection of reducing gas is not resulting in an increase in coke quality demand for the new furnace cases. Furthermore, as superheated reducing gas brings significant amount of thermal energy into the apparatus, the need for the quantity of coke to be combusted in the tuyere decreases.

What has been described here shows that how the coke rate can be decreased to a very low level using a superheated reducing gas injected into the tuyere and optionally a hot reducing gas into the shaft level.

### Gas Flow

It is known that blast furnaces have already successfully been operated with a coarse coke rate of 210 kg/t HM using high pulverised coal injection rates, fed with highly oxygen enriched hot blast (hot air).

The oxygen consumes the injected coal and coke, thus providing the energy to heat the tuyere gas to the high temperature level in the raceway required to melt the reduced ore.

In order to reduce the CO₂ emissions coming from the blast furnace it is desired to eliminate the injected coal and reduce as far as possible the coke rate.

For this reason it is required to reduce the amount of total oxygen injected to the tuyeres to a low level, preferably below 120 Nm³/tHM.

In order to provide the energy at high temperature level to melt the reduced ore, the tuyere gas volume flow rate may only be slightly decreased, by approximately 20% compared to conventional melting and reducing apparatuses, if the typical raceway temperatures of 1800 to 2600° C. are to be maintained.

Since the reducing gas is not anymore produced inside the raceway of the blast furnace, or at least only to a small extend, it is required to produce the reducing gas outside and supply it to the furnace.

Table 4 shows the total mass flow injected to the furnace for all studied cases. It is clear that this value is significantly lower for the new furnace compared to the conventional ones, thanks to the quantity of hydrogen in the gas. The composition of gas injected to tuyere for all cases is presented in table 5.

In order not to exceed the acceptable fluid dynamic conditions in the cohesive zone when having very low coke rates below 200 kg per t of hot metal, we claim therefore that this can only be reached when maintaining the mass flow of the gas injected at the tuyere below 800 kg/t HM (refer to table 4).

In order to do so, the hydrogen content of the gas injected at the tuyere level must be higher than 30%. It needs to be mentioned that although the total mass flow in case of pure hydrogen (100%) is lower than our cases, the coke rate is as high as 274 kg/tHM and 324 kg/tHM.

TABLE 4
Mass of gas injected to tuyere

| | | | | | Case5 | Case6 | | |
|---|---|---|---|---|---|---|---|---|
| | | | | Case 4 | New furnace | New furnace | Case7 | Case8 |
| | | | Case3 | apparatus | with 180 | with 100 | New furnace | New furnace |
| | | | apparatus | with hot | kg/tHM, | kg/tHM, | with 180 | with 100 |
| | Case1 | Case2 | with hot | H₂ injected | without | without | kg/tHM, | kg/tHM, |
| | Apparatus | Apparatus | H₂ injected | to tuyere | shaft | shaft | with shaft | with shaft |
| | 1 | 2 | to tuyere | and shaft | injection | injection | injection | injection |
| Density of hot blast injected | 1.29 | 1.29 | NA | NA | NA | NA | NA | NA |
| to tuyere, kg/Nm³ | | | | | | | | |
| Volume flow rate of hot blast | 820.8 | 740.2 | 0 | 0 | 0 | 0 | 0 | 0 |
| injected to tuyere, Nm³/tHM | | | | | | | | |
| Mass flow rate of hot blast, | 1056.8 | 953.0 | 0 | 0 | 0 | 0 | 0 | 0 |
| kg/tHM | | | | | | | | |
| Density of reducing gas | NA | NA | 0.09 | 0.09 | 0.69 | 0.36 | 0.69 | 0.38 |
| injected to tuyere, kg/Nm³ | | | | | | | | |
| Volume flow rate of reducing | 0 | 0 | 1280 | 760 | 947 | 1200 | 760 | 889 |
| gas injected to tuyere, Nm³/tHM | | | | | | | | |
| Mass flow rate of reducing gas | 0 | 0 | 114 | 68 | 650 | 443 | 523 | 337 |
| injected to tuyere, kg/tHM | | | | | | | | |
| Density of O₂, kg/Nm³ | 1.42 | | | | | | | |
| Volume flow rate of cold O2 | 62.7 | 89.2 | 147.6 | 182.5 | 71.2 | 1.9 | 75.1 | 6 |
| injected to tuyere, Nm³/tHM | | | | | | | | |
| Mass flow rate of cold O₂ | 90 | 127 | 210.9 | 260.7 | 101.7 | 2.7 | 107 | 9 |
| injected to tuyere, kg/tHM | | | | | | | | |
| Total mass flow of injected gas | 1146 | 1080 | 325 | 329 | 751 | 446 | 632 | 346 |
| to the tuyere, kg/tHM | | | | | | | | |

TABLE 5
Gas composition of reducing gas injected to the tuyere.

| | | | | | | | |
|---|---|---|---|---|---|---|---|
| | | | | Case5 | Case6 | | |
| | | | Case4 | New furnace | New furnace | Case7 | Case 8 |
| | | Case3 | apparatus | with 180 | with 100 | New furnace | New furnace |
| | | apparatus | with hot | kg/tHM, | kg/tHM, | with 180 | with 100 |
| | | with hot | H2 injected | without | without | kg/tHM, | kg/tHM, |
| Case1 | Case2 | H2 injected | to tuyere | shaft | shaft | with shaft | with shaft |
| Apparatus1 | Apparatus2 | to tuyere | and shaft | injection | injection | injection | injection |

| | | | | | | | |
|---|---|---|---|---|---|---|---|
| N₂ | vol.-% | 0.0 | 0.0 | 0.6 | 0.6 | 0.5 | 0.5 |
| CO₂ + H₂O | vol.-% | 0.0 | 0.0 | 4.0 | 4.4 | 4.0 | 4.2 |
| CO | vol.-% | 0.0 | 0.0 | 46.9 | 20.4 | 47.4 | 21.3 |
| H₂ | vol.-% | 100.0 | 100.0 | 45.8 | 73.8 | 45.4 | 72.9 |
| CH₄ | vol.-% | 0.0 | 0.0 | 2.7 | 1.1 | 2.7 | 1.1 |
| O₂ | vol.-% | 0.0 | 0.0 | 0.0 | 0.0 | 0.0 | 0.0 |

To estimate the effect of such a lower coke rate on the cohesive zone in terms of pressure drop, the parameters of gas (bosh gas) entering the cohesive zone (CZ) are required. The bosh gas is the result of injected gas into the tuyere, coke combustion (if O2 injected), coke gasification (in case of presence of H2O and CO2), and produced CO by the final reduction reaction in the liquid state (FeO(l)+C(s)→Fe(l)+CO) and non-iron oxides (SiO₂, MnO, P₂O₃, and others) The inventors have surprisingly found that it is possible to reduce the gas volume going through the cohesive zone by injecting part of the gas in the shaft of the furnace. This can be seen in cases 7 and 8 with shaft injection, that the volume of gas traveling through the CZ is significantly lower for the new apparatus.

TABLE 6
The condition of bosh gas traveling through the CZ and estimated pressure drop for all cases.

| | | | | | | Case 5 | Case6 | | |
|---|---|---|---|---|---|---|---|---|---|
| | | | | | Case 4 | New furnace | New furnace | Case7 | Case8 |
| | | | | Case3 | apparatus | with 180 | with 100 | New furnace | New furnace |
| | | | | apparatus | with hot | kg/tHM, | kg/tHM, | with 180 | with 100 |
| | | | | with hot | H2 injected | without | without | kg/tHM, | kg/tHM, |
| | | Case1 | Case2 | H2 injected | to tuyere | shaft | shaft | with shaft | with shaft |
| | | Apparatus1 | Apparatus2 | to tuyere | and shaft | injection | injection | injection | injection |
| N₂ | vol.-% | 46.55 | 44.22 | 0.0 | 0.0 | 0.0 | 0.6 | 0.0 | 0.4 |
| CO₂ | vol.-% | 0 | 0 | 0.0 | 0.0 | 0.0 | 0.0 | 0.0 | 0.0 |
| CO | vol.-% | 46.13 | 47.08 | 18 | 35.0 | 55.0 | 24.6 | 57 | 25.7 |
| H₂ | vol.-% | 7.22 | 8.7 | 82 | 65.0 | 45.0 | 74.8 | 43 | 73.8 |
| H₂O | vol.-% | 0 | 0 | 0.0 | 0.0 | 0.0 | 0.0 | 0.0 | 0.0 |
| Gas volume flow | NM³/tHM | 1398 | 1332 | 1577 | 1147 | 1154 | 1294 | 966 | 969 |
| rate of bosh gas | | | | | | | | | |
| Velocity in | m/t HM | 181.8 | 214.9 | 190.6 | 117.6 | 212.3 | 377.8 | 181.1 | 316.0 |
| cohesive zone | | | | | | | | | |
| Density | kg/Nm³ | 1.16 | 1.15 | 0.3 | 0.50 | 0.73 | 0.38 | 0.75 | 0.39 |
| Mass flow rate | kg/tHM | 1628 | 1530 | 486 | 569 | 839 | 495 | 731 | 381 |
| of bosh gas | | | | | | | | | |
| Passing area of | m² | 14.7 | 11.9 | 15.8 | 18.7 | 10.4 | 6.5 | 10.2 | 5.9 |
| gas | | | | | | | | | |
| Pressure drop | kPa/m | 25.5 | 34.7 | 7.4 | 4.5 | 21.7 | 36.1 | 16.4 | 26.0 |
| in CZ | | | | | | | | | |

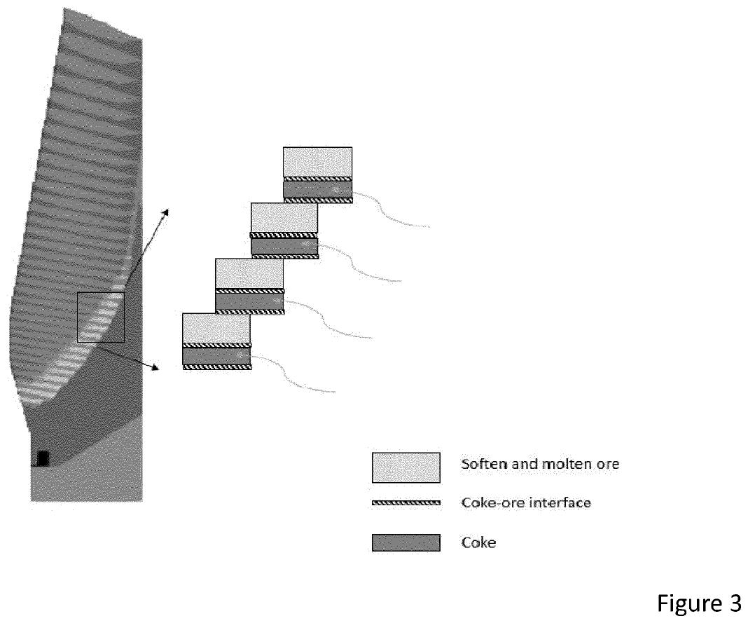

To estimate the pressure drop over the CZ, we have assumed that the ore layers are impenetrable. Moreover, it is believed that some part of molten slag penetrates in the coke layer in the CZ and clogs a part of coke layer. This coke-ore interface layer is also considered as an impenetrate thickness. Thus all ascending gas goes only through the CZ coke layers as illustrated in FIG. 3.

The thickness of coke layer excluding the interface layer is 15 cm for running BFs examples (case 1 and 2). The thickness of interface layer is assumed to be 4 cm. As the coke layer thickness is an important factor for stable furnace operation, this value is kept unchanged for all cases. Advantageously, the minimum coke layer thickness is at least 10 cm (9-11 cm) or at least 15 cm (14 to 16 cm). The material feeding device can be regulated to provide the required thickness.

As the coke rate decreases, the total passing area for the gas in the cohesive zone gets lower. To keep the pressure drop in the cohesive zone in an acceptable range, the volume flow rate and density of bosh gas should be decreased.

As can be seen from the table 6, the pressure drop in the CZ for case 2 is much higher than case 1 due to the lower coke rate.

The new apparatus for a coke rate of 180 kg/t HM can be well operated as the bosh gas can travel through the CZ much smoother. Nevertheless, to reduce the coke rate to the ultimate value of 100 kg/t HM without shaft injection is challenging as the pressure drop in CZ is quite high. This means that the risk of flooding and hanging of burden are higher for the case 6.

This issue can be overcome by increasing the pressure of the injected gas. Higher tuyere gas pressure increases the density and lowers the velocity of gas coming to the furnace. The influence of velocity on the pressure drop is much higher than density since the pressure drop is related to the power 2 of the velocity

$$\frac{Δ p}{L} ∝ ρ {v}^{2} .$$

Nevertheless, higher pressure requires more expensive mechanical devices as well as higher electricity energy demand.

However, this challenge can be mitigated by shaft injection which leads to a lower volume flow rate of injected gas into the tuyere resulting in a lower pressure drop. It can be clearly seen that the pressure drop in case 8 (new furnace) is even lower than in case 2.

Furthermore, as the pressure drop in the CZ and dripping zone is lower for the new apparatus, this allows us to increase the production rate. This is achieved by the effect of the hydrogen on the density of the gas providing the desired pressure drop. To achieve the level of pressure drop of the conventional apparatus (case 2), the production rate could be increased by 15%. Thus once again the advantage of the shaft injection is proved in the case 8.

The following table shows the pressure drop for the case 8 with lower and higher production rates.

TABLE 7

| | | | Case8 | |
|---|---|---|---|---|
| | | | | New furnace |
| | | | New furnace | with 100 kg/ |
| | | | with 100 kg/ | tHM, with |
| | | Case 2 | tHM, with | shaft |
| | | appa- | shaft | injection, more |
| | | ratus2 | injection | production |
| Production rate | tHM/h | 299 | 300 | 344 |
| Gas volume flow | NM3/ | 1332 | 969 | 967 |
| rate of bosh gas | tHM | | | |
| Velocity in | m/t HM | 214.9 | 316.0 | 312.7 |
| cohesive zone | | | | |
| Density | kg/Nm3 | 1.15 | 0.39 | 0.41 |
| Mass flow rate | kg/tHM | 1530 | 381 | 392 |
| of bosh gas | | | | |
| Passing area of | m2 | 14.7 | 5.9 | 5.9 |
| gas | | | | |
| Pressure drop | kPa/m | 34.7 | 26.0 | 34.3 |
| in CZ | | | | |

### Plasma Torches

The plasma torches disclosed in this application can be DC or AC plasma torches.

Alternating current 3-phase plasma torches can show the following characteristics.

The core of the plasma can reach about 15000K or even higher.

Graphite electrodes, most preferably, can be used having an outer diameter of 50-200 mm, 100-150 mm or 130 mm).

An AC voltage of 100V-1500V can be applied. Of note, such a voltage can also be applied in DC torches. Higher voltage, say in the order of kV, is also possible to be applied to reach higher power output, say 2-8 MW.

The inter-electrode distance of the plasma torch is adjustable (gaps of 0-100 mm or 40 mm can be reached, higher gaps of 100 mm are possible). The adjustability allows for easy plasma ignition and higher plasma stability.

The plasma control can be based on visual observation: pictures of the plasma that are continuously captured by a camera are benchmarked against steady-state plasma pictures, using a relevant software. Then, respective changes are imposed (i.e. inter-electrode distance, voltage amplitude etc.) in order to retain the plasma in stable regime.

The plasma torch can operate for weeks or months if spare electrodes are continuously charged in an electrodes magazine.

There are 6 arc plasmas taking place each period between the 3 electrodes playing alternatively the role of anode and cathode, one at a time.

The alternating ignition point of plasma makes it more diffusive, resulting in higher gas volume treatment than direct current plasma torches. Maybe 30% of the gas can be treated per single pass.

The lifetime of the electrodes, specifically in case of graphite electrodes, can be increased if the reducing gas has low concentrations of oxygenated species, i.e., H₂O and CO₂. Reducing gas may comprise a reductant to oxidant ratio (CO+H₂)/(CO₂+H₂O) in % (vol/vol) that is bigger than 7, 8, or 9. The ((CO+H₂)/(CO₂+H₂O))-ratio may be 6-80, 7-30, or 8-12.

A minimum reduction degree of the gas should therefore be maintained and/or the concentration of H₂O plus CO₂ shall be limited to values below 35 vol %, 10 vol %, preferably below 5 vol %.

### EXAMPLES

The following examples are also provided:

Example 1. An iron ore reducing and melting apparatus comprising:
a furnace comprising from bottom to top: a hearth, a tuyere level, a shaft level and a top level, said furnace comprising at least one first gas injector on the tuyere level
at least one reducing gas generator connected to the at least one first injector, wherein the first injector is adapted to provide reducing gas comprising 30-100% (vol/vol) hydrogen, having a density of 0.15-0.85 kg/Nm3 and a mass flow rate of 300 to 800 kg/tHM or/and a volume flow rate of 500-1300 Nm3/tHM on the tuyere level, and to operate at a coke rate of below 200 kg/t hot metal.

Example 2. Iron ore reducing and melting apparatus according to example 1, further comprising at least one second gas injector on the shaft level

Example 3. Iron ore reducing and melting apparatus according to examples 1 or 2, wherein the at least one first gas injector comprises at least one electrically driven heater.

Example 4. Iron ore reducing and melting apparatus according to any of the above examples, wherein the at least one first gas injector is adapted to heat the reducing gas to 1600° C.-2600° C., preferably 2100-2200° C., to inject the reducing gas at a volume flow of 500 1300 Nm3/t hot metal into the blast furnace, to inject the reducing gas at a pressure of at least 2 to up to 10 bar absolute, preferably 4-5 bar absolute, or/and the at least one electrically driven heater of the at least one first gas injector is adapted to operate at an electric power of 200-600 kwh/t of hot metal.

Example 5. Iron ore reducing and melting apparatus according to example 3, wherein the heater is a plasma torch, being an electrode-comprising or electrodeless plasma torch.

Example 6. Iron ore reducing and melting apparatus according to example 5, wherein the plasma torch is an electrode-comprising plasma torch, and the iron ore reducing and melting apparatus is further comprising a plasma torch electrode exchanging/amendment device adapted to automatically replace at least one used or eroded electrode of the plasma torch with an unused electrode/amend the used electrode with at least 1 new electrode, said plasma torch electrode exchanging/amendment device comprising a magazine for unused electrodes.

Example 7. Iron ore reducing and melting apparatus according to example 5, wherein the plasma torch is an alternating current plasma torch, more preferably a 3-phase alternating current plasma torch, having 3 or a multiplicity of 3 electrodes; or wherein the plasma torch is a direct current plasma torch having 2 or a multiplicity of 2 electrodes.

Example 8. Iron ore reducing and melting apparatus according to any of the above examples, wherein the blast furnace comprises a plurality of first or/and second gas injectors, and wherein the plurality of first and/or second gas injectors are arranged substantially equidistantly and/or circularly, wherein optionally the outlets of the respective injectors are independently from each other evenly distributed at distance between 0.5 and 2.5 m, and preferably between 1.0 and 1.5 m between each other.

Example 9. Iron ore reducing and melting apparatus according to any of the above examples, further comprising a sensor adapted to analyze the composition of the gas at the top level. with regard to the CO, CO2, H2 concentration of the gas, optionally also adapted to analyse the composition of the gas with regard to the H2O, N2, or CH4 concentration in the gas, or/and a temperature sensor adapted to measure the temperature of the gas at the top level; and/or further comprising a sensor for humidity measurement after gas cleaning and pretreatment.

Example 10. Iron ore reducing and melting apparatus according to example 9, further comprising a gas injector regulating device configured to adapt the composition of the gas and/or the volume of the gas injected by the first and/or second gas injectors based on the determined gas composition at the top level and optionally configured to adapt the composition of the gas and/or the volume of the gas based on the composition of the hot metal output-ted by the apparatus and the hot metal production rate

Example 11. Iron ore reducing and melting apparatus according to any of the above examples, further comprising an oxygen supply device adapted to inject oxygen at less than 120 Nm3/t hot metal, less than 80 Nm3/t hot metal, less than 40 Nm3/t hot metal, less than 30 Nm3/t hot metal, inject 0 Nm3/t hot metal into the blast furnace.

Example 12. Iron ore reducing and melting apparatus according to any of the above examples, further comprising a gas cleaning device, wherein optionally the gas cleaning devices is adapted to control the top pressure of the furnace and/or to recycle the top gas of the blast furnace.

Example 13. Iron ore reducing and melting apparatus according to example 12, the apparatus adapted to provide hydrogen to the gas coming from the gas generator and being supplied to the gas to the second injector and/or adapted to add hydrogen upstream or to the inlet of the reducing gas generator.

Example 14. Iron ore reducing and melting apparatus according to example 13, wherein the reducing gas generator comprises a CO2 separation device or/and a catalytic reformer, or/and a non-catalytic reformer, preferably a regenerative reformer without a catalyst configured to provide reducing gas at a temperature of 1100° C. or higher; wherein optionally the reducing gas generator is configured to provide reducing gas to the tuyere level, the shaft level or both, and the reducing gas generators for the tuyere and shaft level can be different.

Example 15. Method for reducing and melting iron ore in a furnace comprising the steps of:
injecting a superheated reducing agent at a temperature of 1600° C.-2600° C. into the furnace at tuyere level; wherein the volume flow of the reducing gas injected at tuyere level is 500-1300 Nm3/t hot metal and the reducing gas comprises 30-100% (vol/vol) H2 has a density of 0.15-0.85 kg/Nm3 and a mass flow rate of 300 to 800 kg/tHM or/and wherein the coke rate of the method is below 200 kg/t hot metal;
thereby providing hot metal

Example 16. The method of example 15, further comprising injecting reducing agent at a temperature of 800° C.-1000° C. into the furnace at shaft level;

Example 17. Method of example 16, injecting reducing gas at shaft level substantially along the circumference of the furnace such that the gas ascending from the cohesive zone is centered within the furnace.

Example 18. Method of any of examples 15-17 for reducing iron ore in a blast furnace, wherein the ratio between volume flow of the reducing gas injected at shaft level and the volume flow of the reducing gas injected at tuyere level is from 0:1 to 1:1, preferably, 0.6 to 0.65.

Example 19. Method of examples 15-18, wherein the hydrogen in the reducing gas comprises hydrogen generated from renewable energy fully/partially and/or from natural gas reforming with carbon capture and/or wherein the reducing gas is heated and/or superheated electrically using renewable energy fully/partially and/or lean CO2 electricity as from nuclear.

Example 20. Method of examples 15-19 wherein recycled top gas and or other steel making gases are integrating the mix gas entering the reducing gas generator after or not being treated in the gas cleaning device.

Example 21. Method of examples 15-20, wherein the reducing gas generator comprises PSA, VPSA, MEA, or other CO2 separation technologies as well as a reducing gas compression and heating device wherein devices can be arranged in different configurations preferably compression, separation heating.

Example 22. Method of examples 15-21, comprising reforming, catalytically and/or non-catalytically.

Example 23. Method of examples 15-22 wherein the reducing gas generator and/or the gas cleaning de-vice is fed at least partially with cold hydrogen.

Example 24. Method of examples 15-23, wherein the minimum coke layer thickness is at least 10 cm, for example, 9-11 cm, or at least 15 cm, for example, 14 to 15 cm.

### REFERENCE NUMBERS

1: iron ore reducing and melting apparatus
2: blast furnace
3: tuyere level
4: shaft level
5: top level
6: first gas injector
7: reducing gas generator
8: lock hopper
9: second gas injector
10: hearth
11: oxygen supply device
12: gas cleaning device
13: gas sensor
14: gas injector regulating device
15: belly
16,17: sensors
21: coke layer
22: shaft region with stack
23: cohesive zone
24: dripping zone
25: race way into which gas is injected via tuyere
26: dead man
27: shaft injection point for reducing gas
28: tuyere injection point for oxygen, hot blast, and/or reducing gas
29: material comprising ore in a various forms of processing

1. An iron ore reducing and melting apparatus, comprising:
a furnace comprising from bottom to top: a hearth, a tuyere level, a shaft level and a top level, said furnace comprising at least one first gas injector on the tuyere level; and
at least one reducing gas generator connected to the at least one first injector, wherein the first injector is adapted to provide reducing gas comprising 30-100% (vol/vol) hydrogen, having a density of 0.15-0.85 kg/Nm³ and a mass flow rate of 300 to 800 kg/tHM or/and a volume flow rate of 500-1300 Nm³/tHM on the tuyere level, and to operate at a coke rate of below 200 kg/t hot metal.

2. The iron ore reducing and melting apparatus according to claim 1, further comprising at least one second gas injector on the shaft level.

3. The iron ore reducing and melting apparatus according to claim 1, wherein the at least one first gas injector comprises at least one electrically driven heater.

4. The iron ore reducing and melting apparatus according to claim 1, wherein the at least one first gas injector is adapted to heat the reducing gas to 1600° C.-2600° C., 1800° C.-2600° C., 2000° C.-2600° C., or 2100-2200° C.

5. The iron ore reducing and melting apparatus according to claim 1, wherein the at least one first gas injector is adapted to inject the reducing gas at a volume flow of 500-1300 Nm³/t hot metal into the blast furnace.

6. The iron ore reducing and melting apparatus according to claim 1, wherein the at least one first gas injector is adapted to inject the reducing gas at a pressure of at least 2 to up to 10 bar absolute.

7. The iron ore reducing and melting apparatus according to claim 1, wherein the at least one electrically driven heater of the at least one first gas injector is adapted to operate at an electric power of 200-600 kwh/t of hot metal.

8. The iron ore reducing and melting apparatus according to claim 3, wherein the heater is an electric resistance heater.

9. The iron ore reducing and melting apparatus according to claim 3, wherein the heater is a plasma torch.

10. The iron ore reducing and melting apparatus according to claim 9, wherein the plasma torch is an electrode-comprising plasma torch, and the iron ore reducing and melting apparatus further comprises a plasma torch electrode exchanging/amendment device adapted to automatically replace at least one used or eroded electrode of the plasma torch with an unused electrode/amend the used electrode with at least 1 new electrode; or/and wherein the plasma torch is an electrode-comprising plasma torch, and the iron ore reducing and melting apparatus is further comprising an electrode paste column or paste feeder.

11. The iron ore reducing and melting apparatus according to claim 10, wherein said plasma torch electrode exchanging/amendment device further comprises a magazine for unused electrodes.

12. The iron ore reducing and melting apparatus according to claim 9, wherein the plasma torch is an alternating current plasma torch, having 3 or a multiplicity of 3 electrodes; or wherein the plasma torch is a direct current plasma torch having 2 or a multiplicity of 2 electrodes.

13. The iron ore reducing and melting apparatus according to claim 9, wherein the plasma torch has an electric power rating of 1 to 10 MW.

14. The iron ore reducing and melting apparatus according to claim 9, the plasma torch is an electrodeless plasma torch selected from the group consisting of inductively ignited plasma torches, microwave plasma torches, radiofrequency plasma torches or a combination thereof.

15. The iron ore reducing and melting apparatus according to claim 1, wherein the blast furnace comprises a plurality of first or/and second gas injectors, and wherein the plurality of first and/or second gas injectors are arranged substantially equidistantly and/or circularly.

16. The iron ore reducing and melting apparatus according to claim 1, further comprising a sensor adapted to analyze the composition of the gas at the top level with regard to the CO, CO2, H2 concentration of the gas, or/and a temperature sensor adapted to measure the temperature of the gas at the top level; and/or further comprising a sensor for humidity measurement after gas cleaning and pretreatment.

17. The iron ore reducing and melting apparatus according to claim 16, further comprising a gas injector regulating device configured to adapt the composition of the gas and/or the volume of the gas injected by the first and/or second gas injectors based on the determined gas composition at the top level and optionally configured to adapt the composition of the gas and/or the volume of the gas based on the composition of the hot metal outputted by the apparatus and the hot metal production rate

18. The iron ore reducing and melting apparatus according to claim 1, further comprising an oxygen supply device adapted to inject oxygen at less than 120 Nm³/t hot metal.

19. The iron ore reducing and melting apparatus according to claim 1, further comprising an oxygen supply device configured for injecting oxygen at the tuyere level of the smelting furnace via an oxygen injection port.

20-31. (canceled)

32. A method for reducing and melting iron ore in a furnace comprising:
injecting a superheated reducing agent at a temperature of 1600° C.-2600° C. into the furnace at tuyere level; wherein the volume flow of the reducing gas injected at tuyere level is 500-1300 Nm³/t hot metal and the reducing gas comprises 30-100% (vol/vol) H₂ has a density of 0.15-0.85 kg/Nm³, and a mass flow rate of 300 to 800 kg/tHM and/or wherein the coke rate of the method is below 200 kg/t hot metal; and
thereby providing hot metal.

33-62. (canceled)
